(19) United States
(12) Patent Application Publication
(10) Pub. No.: US 2007/0220421 A1
(43) Pub. Date: Sep. 20, 2007

(54) Adaptive Content Service

(75) Inventors: Timothy Sharpe, Redmond, WA (US); Oliver B. Colbert, Redmond, WA (US); Melody D. Litovkin, Redmond, WA (US); Rainer J. Romatka, Bellevue, WA (US); Milton M. Wong, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/276,849

(22) Filed: Mar. 16, 2006

(51) Int. Cl. G06F 17/00; G06F 15/00

(52) U.S. Cl. 715/517

(57) ABSTRACT

Adaptive content techniques are described. In an implementation, content for display on a client device is adapted by forming a plurality of panels from a page of the content and forming an identifier for each of the panels. At least one of the panels is configured for output by the client device such that each other panel is accessible via a respective identifier that is displayable concurrently with the at least one panel.

### BACKGROUND

The pervasiveness of the Internet, and particularly the World Wide Web, and its corresponding affects on aspects of everyday life is ever increasing. From web pages that include news and sports articles to downloadable songs, web logs, and so on, the variety of content available via the Internet continues to expand and thereby also expands the amount of information that is available to users.

Traditional content, however, was typically configured for output on “thick” client devices, such as desktop personal computers and modern laptop computers. The variety of client devices that are available to the users, on the other hand, has also continued to expand such that some of the traditional functionality that was available to users via these “thick” client devices is now also available to users of “thin” client devices, such as “smart” phones, personal digital assistants (PDAs), and so on.

A user of a smart phone, for instance, may interact with the phone to browse the Internet, read email, and so forth. However, even though the phone may include the vast majority of functionality available from a “thick” client device (e.g., a desktop personal computer), the phone may still have some resources which are limited when compared to the thick client device. For instance, the phone may have a limited amount of available display area. Therefore, content which was configured for output on the thick client device may not be as suitable for output on the thin client device.

### SUMMARY

An adaptive content service is described which may employ techniques to adapt content for display on a client device. In an implementation, the adaptive content service adapts content for display on a client device by forming a plurality of panels from a page of the content and forming an identifier for each of the panels. At least one of the panels is configured for output by the client device such that each other panel is accessible via a respective identifier that is displayable concurrently with the at least one panel.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an illustration of an environment in an exemplary implementation that is operable to employ adaptive content techniques.

FIG. 2 is a flow diagram depicting a procedure in an exemplary implementation in which a page of content is adapted to form a plurality of panels, each being displayable with identifiers of each other panel that are selectable to navigate to the respective panel.

FIG. 3 is an illustration of an exemplary page of content configured as a web page as being adapted for display by the client device of FIG. 1 by dividing the page into panels through execution of the procedure of FIG. 2.

FIG. 4 is an illustration of an exemplary implementation of the client device of FIG. 1 as displaying a panel formed from the page of content of FIG. 3 and identifiers of other panels that were formed through execution of the procedure of FIG. 2.

FIG. 5 is a flow diagram depicting a procedure in an exemplary implementation showing additional content adaptation techniques that may be employed to adapt content for rendering by the client device of FIG. 1.

The same reference numbers are utilized in instances in the discussion to reference like structures and components.

### DETAILED DESCRIPTION

Overview

Even though the functionality that is available via “thin” client devices is ever increasing, this functionality may still be limited when compared with “thick” client devices. For example, a thin client device (e.g., a wireless phone) may have limited display area to display content when compared with a thick client device, such as a desktop personal computer. The limited functionality may therefore affect content that is displayable on the thin client device. Continuing with the previous example, content configured for display on a relatively large display device (e.g., a monitor of the desktop personal computer) may not be configured for output by the wireless phone, thereby adversely affecting which content is permitted for display on the wireless phone and/or how the content is displayed.

Accordingly, techniques are described that adapt content for rendering by a client device, such as a “thin” client device as previously described. For example, an adaptive content service may be configured to receive requests for content from a client device. The adaptive content service may then retrieve the requested content (e.g., a web page) from a content provider and adapt the content for display on the client device. A variety of techniques may be employed to adapt the content.

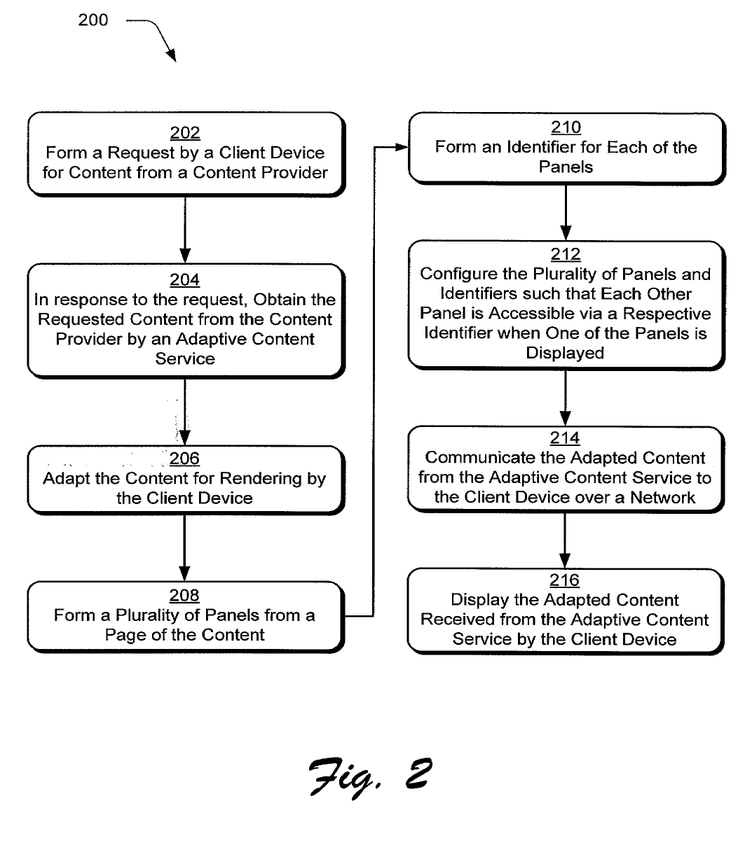

In a first example, a plurality of panels and identifiers are formed from a page of the content. Each identifier corresponds to a respective one of the panels. Each panel may then be configured for display with identifiers of other panels not currently being displayed such that each other panel is accessible while the panel is being displayed. Additionally, a variety of techniques may be used to form the identifiers, such as by examining metadata, text included in the content, and so on. Further discussion of content adaptation through formation of panels and identifiers may be found in relation to FIGS. 2-4.

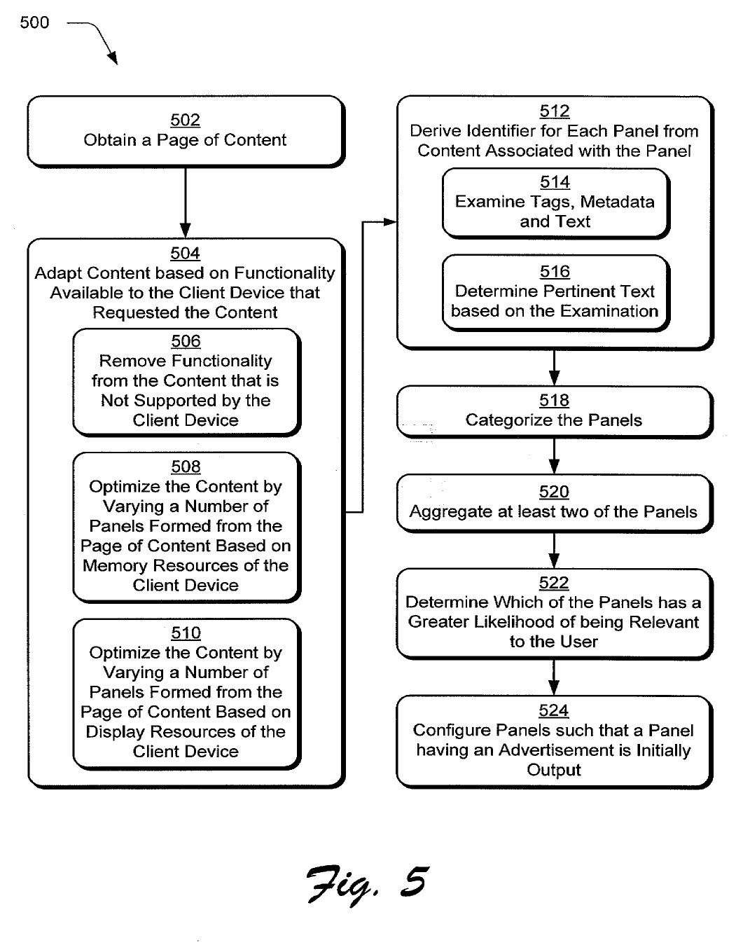

A variety of other examples of content adaptation techniques are also contemplated. For example, a determination may be made that a particular one of the panels includes an advertisement and therefore that panel may be displayed first by the client device. In another example, a determination is made as to which panel is most relevant to a user of the client device, such as most relevant to a search query input by the user. The most relevant panel may then be displayed initially by the client device before other less relevant panels. In a further example, the content is adapted based on the functionality supported by the client device, such as to remove features not supported by the client device, form a number of panels based on the memory resources of the client device, form a number of panels based on the display resources of the client device, and so on. In yet another example, the panels may be categorized, such as by topic, commonalities between respective panels, and so on. In still yet another example, panels may be aggregated to form an aggregated panel. A variety of other examples are also contemplated, further discussion of which may be found in relation to FIG. 5.

In the following discussion, an exemplary environment is first described that is operable to perform adaptive content configuration techniques. Exemplary procedures are then described which may be employed in the exemplary environment, as well as in other environments.

Exemplary Environment

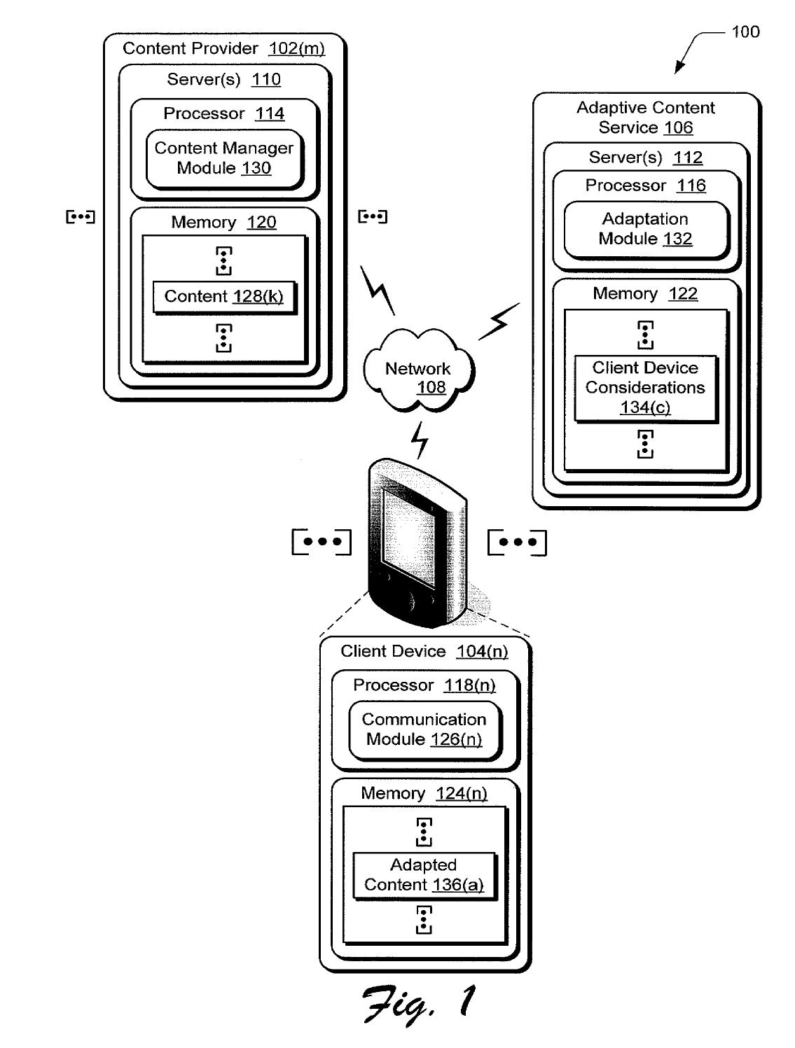

FIG. 1 illustrates an environment 100 in an exemplary implementation that is operable to employ techniques to adapt content for rendering by a client device. The illustrated environment 100 includes a plurality of content providers 102(m) (where “m” can be any integer from one to “M”), a plurality of client devices 104(n) (where “n” can be any integer from one to “N”) and an adaptive content service 106 that are communicatively coupled, one to another, via a network 108. The client devices 104(n) may be configured in a variety of ways for accessing the network 108. For instance, client device 104(n) is illustrated in FIG. 1 as a “thin” client device (e.g., a personal digital assistant) having one or more resources which are limited when compared to a “thick” client device, such as a traditional desktop personal computer, server, and so on. For example, the thin client device may have limited display, memory, processor and/or network resources when compared to a notebook computer.

Although the client device 104(n) is illustrated as a thin client device, the client device 104(n) may also be configured as a traditionally “thick” client device that can employ the content adaptation techniques. For example, the client device 104(n) may be configured as a desktop computer having a limited display area when compared with a projector. Therefore, although the following discussion will refer to thin client devices, these techniques may also be employed to adapt content for rendering by thick client devices without departing from the spirit and scope thereof.

The content provider 102(m) and adaptive content service 106 are each illustrated as being implemented through use of one or more respective servers 110, 112. Accordingly, the servers 110, 112 and the client device 104(n) each include a respective processor 114, 116, 118(n) and respective memory 120, 122, 124(n). Processors are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. Alternatively, the mechanisms of or for processors, and thus of or for a computing device, may include, but are not limited to, quantum computing, optical computing, mechanical computing (e.g., using nanotechnology), and so forth. Additionally, although a single memory 120, 122, 124(n) is shown, respectively, for the servers 110, 112 and client device 104(n), a wide variety of types and combinations of memory may be employed, such as random access memory (RAM), hard disk memory, removable medium memory, and other computer-readable media.

Additionally, although the network 108 is illustrated as the Internet, the network may assume a wide variety of configurations. For example, the network 106 may include a wide area network (WAN), a local area network (LAN), a wireless network, a public telephone network, an intranet, and so on. Further, although a single network 108 is shown, the network 108 may be configured to include multiple networks. For instance, the content provider 102(m) and the adaptive content service 106 may be communicatively coupled via a corporate Intranet to communicate, one to another. Additionally, both the content provider 102(m) and the adaptive content service 106 may be communicatively coupled to the clients 104(n) over the Internet. In another instance, the client device 104(n) is communicatively coupled to the adaptive content service 106 via a wireless network and the adaptive content service 106 is communicatively coupled to the content providers 102(m) via the Internet. A wide variety of other instances are also contemplated.

The client device 104(n) is illustrated as executing a communication module 126(n) on the processor 118(n), which is also storable in memory 124(n). The communication module 126(n) is representative of functionality that enables the client device 104(n) to communicate over the network 108 with the content providers 102(m) and/or the adaptive content service 106. For example, the communication module 126(n) may be configured as a browser to request content 128(k) (where “k” can be any integer from one to “K”) from the content provider 102(m). The content provider 102(m), for instance, may execute a content manager module 130 on the processor 114, which is also storable in memory 120, to process the request from the client device 104(n), such as to locate particular content 128(k).

As previously described, however, the client devices 104(n) may vary in their capabilities to render the content 128(k). For example, the client devices 104(n) may have different hardware (e.g., processor 118(n), memory 124(n) and/or display), network, and/or software capabilities. Therefore, the adaptive content service 106 may be employed to adapt the content 128(k) for use by the client devices 104(n). For instance, the adaptive content service 106 is illustrated as executing an adaptation module 132 on the processor 116, which is also storable in memory 122. The adaptation module 132 is representative of functionality that adapts the content 128(k) for rendering by the client device 104(n) based on a variety of client device considerations 134(c) (where “c” can be any integer from one to “C”). For example, the client device considerations 134(c) may describe available display area of a display device of the client device 104(n), amount of processor 118(n) resources, amount of memory 124(n) resources, amount of available bandwidth when connecting to the network 108, and so on.

The adaptation module 132 may use the client device considerations 134(c) to adapt the content 128(k) from the content provider 102(m) and communicate adapted content 136(a) (where “a” can be any integer from one to “A”) for storage (e.g., in memory 124(n)) and rendering by the client device 104(n). The adapted content 136(a) may be configured in a variety of ways for rendering by the client device 104(n), further discussion of which may be found in relation to the following figures. It should be noted that although the adaptive content service 106 is illustrated as a stand-alone service, functionality of the adaptive content service 106 may be distributed throughout the environment, such as by employing portions of the functionality at the content provider 102(m) and the client device 104(n). A variety of other examples are also contemplated.

Generally, any of the functions described herein can be implemented using software, firmware (e.g., fixed logic circuitry), manual processing, or a combination of these implementations. The terms “module,” “functionality,” and “logic” as used herein generally represent software, firmware, or a combination of software and firmware. In the case of a software implementation, the module, functionality, or logic represents program code that performs specified tasks when executed on a processor (e.g., CPU or CPUs). The program code can be stored in one or more computer readable memory devices. The features of the adaptation techniques described below are platform-independent, meaning that the techniques may be implemented on a variety of commercial computing platforms having a variety of processors.

Exemplary Procedures

The following discussion describes adaptation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will also be made to the exemplary environment 100 of FIG. 1.

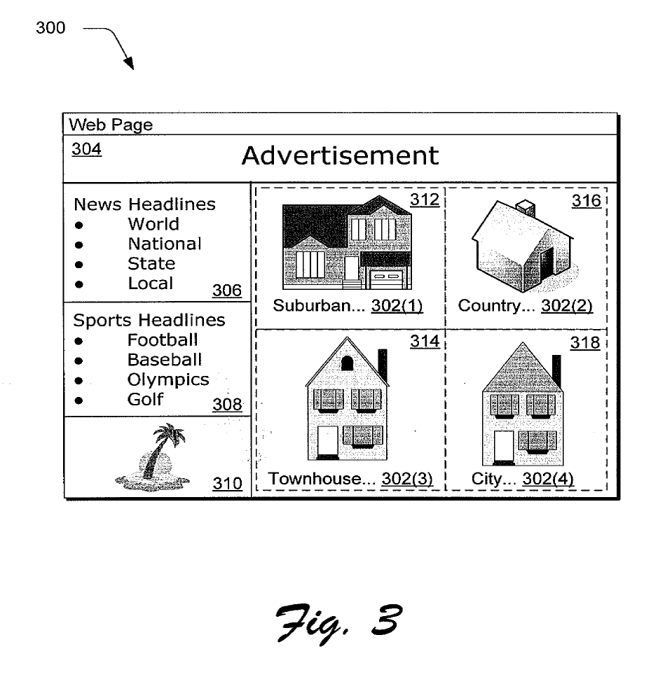

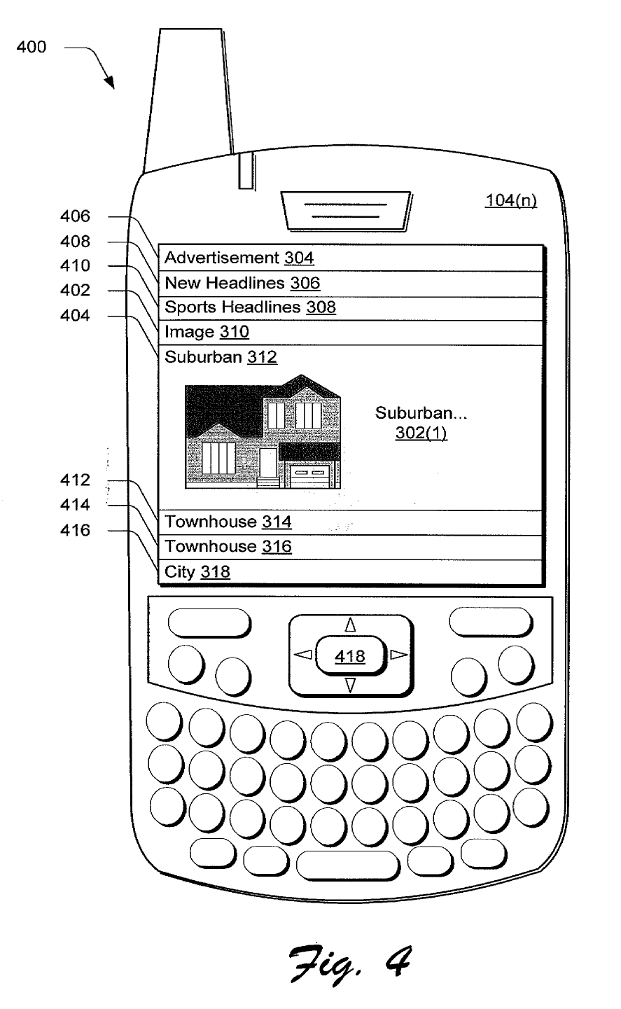

FIG. 2 depicts a procedure 200 in an exemplary implementation in which a page of content is adapted to form a plurality of panels, each being displayable with identifiers of each other panel that are selectable to navigate to the respective panel. During the discussion of the procedure 200 of FIG. 2, reference will also be made to an exemplary page of content 300 of FIG. 3 that may be adapted to form a panel and identifiers, examples of which are shown in the exemplary implementation 400 of FIG. 4.

A request is formed by a client device for content from a content provider (block 202). For example, a user may interact with the communication module 126(n) configured as a browser to request the web page 300 of FIG. 3. Rather than request the content (e.g., the web page 300) directly from the content provider 102(m), for instance, the request may be communicated to the adaptive content service 106.

In response to the request, the adaptive content service 106 obtains the requested content 128(k) from the content provider 102(m) (block 204), such as through execution of the adaptation module 132. The adaptive content service 106 then adapts the content for rendering by the client device 104(n) (block 206).

For example, a plurality of panels may be formed from the page of content 300 (block 208). The web page 300 of FIG. 3, for instance, includes a plurality of sections that include an advertisement, news headlines, sports headlines, an image of an island, and images and associated text 302(1)-302(4) of multiple homes. Each of these sections may then be used to form one or more panels 304-318.

The sections including the advertisement, news headlines, sports headlines and the image of the island, for instance, may each be formed into respective panels 304-310. The section including images of the plurality of homes and associated text, however, may be further divided into a plurality of panels 312-318 due to size constraints, i.e., this section may be too large for proper display on the client device 104(n). Therefore, the panels 304-318 may be configured such that each of them is separately displayable by the client device 104(n) at any one time, an example of which is shown in the exemplary implementation 400 of FIG. 4 in which the client device 104(n) is configured as a wireless phone that is displaying the panel 312 that contains the suburban home.

An identifier for each of the panels may also be formed (block 210) through execution of the adaptation module 132. A variety of techniques may be employed to form the identifiers. For instance, text included in the respective panels may be used to identify the panel, such as “advertisement” for panel 304 “country” for panel 316, and so on. Additionally, tags may also be used to determine which text to use, such as by finding a parent tag indicating a likely title of the section (e.g., “news headlines” for panel 306 and “sports headlines” for panel 308), tags that are “hidden” from display by the client device 104(n), and so on. In another instance, an image may include metadata that describes the image but is not generally output by the client device 104(n). Therefore, this metadata may also be used to form an identifier of the image. In yet another instance, generic identifiers may be used when text is not available. For example, the image of the island may not have associated descriptive information and therefore a generic identifier 402 “image” is shown for the respective panel 310 in FIG. 4. A variety of other techniques may also be utilized, further discussion of which may be found in relation to FIG. 5.

The plurality of panels and identifiers are then configured such that each other panel is accessible via a respective identifier when one of the panels is displayed (block 212). Therefore, when the adapted content is communicated over the network 108 to the client 104(n) (block 214), the client device 104(n) may display the adapted content (block 216) and access desired portions of the content (i.e., the panels) directly from any one of the panels.

For example, the client device 104(n) of FIG. 4 is illustrated as displaying panel 312, which includes an image of a suburban house, the text “suburban . . . ” 302(1) associated with the image, and an identifier 404 that is derived from the text which is also illustrated as “suburban” in this instance. Identifiers 402, 406-416 for each of the other respective panels 304-310, 314-318 are also displayed concurrently with the panel 312. Each of these identifiers 402, 406-416 is selectable (e.g., through use of a cursor control device 418) to cause display of a respective panel. Thus, in this example when one of the panels formed from the page 300 of FIG. 3 is displayed, the user may navigate to each of the other panels formed from the page 300 directly from the displayed panel. Further, the identifiers may aide the user in selecting a desired panel 304-318 without navigating to each of the panels 304-318 individually as was required using traditional techniques. For example, by viewing the identifiers, the user is informed as to content available via a respective panel and may thus choose a desired panel. A variety of other adaptation techniques may be employed by the adaptive content service 106, further discussion of which may be found in relation to the following figure.

FIG. 5 depicts a procedure 500 in an exemplary implementation in which additional content adaptation techniques are employed to adapt content for rendering by the client device 104(1) of FIG. 1. A page of content is obtained (block 502). For example, the client device 104(n) may request the page of content from the adaptive content service 106, which then obtains the content 128(k) from the content provider 102(m). In another example, the client device 104(n) may obtain the content 128(k) from the content provider 102(m) directly, i.e., the client device 104(n) and/or the content provider 102(m) incorporates the functionality of the adaptive content service 106. A variety of other examples are also contemplated.

The content is adapted based on functionality available to the client device that requested the content (block 504). For example, the adaptation module 132 may examine the client device considerations 134(c) to determine which functionality is supported by the client device 104(n), such as image formats, available display area, memory resources, processing resources, and so on. These client device considerations 134(c) may be obtained from a variety of sources, such as preconfigured in the adaptive content service 106, obtained from the client device 104(n) itself, and so on.

A variety of techniques may be performed to adapt the content based on the available functionality of the client device. For instance, functionality may be removed that is not supported by the client device (block 506), which may include removing unsupported video, reformatting of images, text and/or audio to supported formats, and so on.

Additionally, the content may be optimized based on the available functionality. For instance, the content may be optimized by varying a number of panels formed from the page of content based on memory resources of the client device (block 508). For example, a client device having significant memory resources may be provided with a fewer number of panels, which corresponding results in fewer identifiers and provides more content for display at any one time. In another instance, the content may be optimized by varying a number of panels formed from the page of content based on display resources of the client device (block 510). For instance, a client device having a greater amount of display area may be provided with a fewer number of panels, which also results more content for display at any one time. A variety of other instances are also contemplated.

An identifier is also derived for each panel based on content associated with the panel (block 512). As previously described, the adaptation module 132 may example tags, metadata and text (block 514) included in content that was portioned into the particular panel. A determination may then be made as to which text is pertinent based on the examination (block 516). For example, techniques similar to those employed by a search engine may be used to determine which text included in the content is most likely to be descriptive of the content overall, such as through examination of a tag that indicates “title”, is a parent of each other tag, and so on.

The panels may also be categorized (block 518) for display. For instance, the identifiers may be grouped based on category when displayed such that similar identifiers as determined by category are displayed together. In another example, an identifier may be formed for the category that is navigable to cause identifiers of panels in that category to be displayed. A variety of other examples are also contemplated.

At least two of the panels may also be aggregated (block 520). For example, a determination may be made to aggregate panels based on available display area, content similarities, and so on.

A determination may also be made as to which of the panels has a greater likelihood of being relevant to the user (block 522). The content, for instance, may be retrieved in response to a search request input by the user for information relating to a “mud slide”. After the panels of the retrieved content are formed, the adaptation module 132 may determine which of the panels is most likely to include desired content relating to the search query, such as through a keyword count and other techniques. Therefore, when the content is displayed, the panel which has been determined to be most likely to be relevant may be displayed initially, provided with an additional identifier indicating relative likelihood of relevance, and so on. Keywords (e.g., the search terms) may also be identified (e.g., highlighted, underlines, and so on) in the panel when performing the adaptation. A variety of other techniques that may be employed to determine and/or display relevancy are also contemplated.

The panels may also be configured such that a panel having an advertisement is initially output (block 524). For example, the adaptive content service 106 may receive funds for display of advertisement conjunction with providing the adaptation techniques, whether as a stand-alone service or as part of the content provider 102(m) itself. Therefore, a panel having an advertisement may be displayed first when the content is output by the client device to ensure that the advertisement is viewed by the user. The panel may have a variety of sources, such as originally within the content itself and/or added by the adaptive content service 106.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising adapting content for display by a client device by:
forming a plurality of panels from a page of the content;
forming an identifier for each said panel; and
configuring at least one said panel for output by the client device such that each other said panel is accessible via a respective said identifier that is displayable concurrently with the at least one said panel.

2. A method as described in claim 1, wherein:
the content is obtained from a content provider by an adaptive content service;
the client device requested the content from the adaptive content service;
the client device and the content provider are communicatively coupled to the adaptive content service via a network; and
the adaptive content service performs the adapting.

3. A method as described in claim 1, wherein the page is a web page.

4. A method as described in claim 1, wherein each said identifier, when displayed, is selectable to cause a respective said panel to be output for display.

5. A method as described in claim 1, wherein the adapting includes aggregating at least two said panels to form an aggregated panel that is configured for display on the client device.

6. A method as described in claim 1, wherein the adapting includes:
determining that a particular said panel includes an advertisement; and
configuring the content for output on the client device such that the particular said panel is initially output.

7. A method as described in claim 1, wherein the identifiers are formed from content associated with a respective said panel.

8. A method as described in claim 1, wherein the identifiers are formed from metadata associated with a respective said panel.

9. A method as described in claim 1, wherein the adapting includes removing functionality from the content that is not supported by the client device before the content is communicated to the client device.

10. A method as described in claim 1, wherein the adapting includes categorizing the panels.

11. A method as described in claim 1, wherein the adapting includes optimizing the content by varying a number of panels formed from the page of content based on memory resources of the client device.

12. A method as described in claim 1, wherein the adapting includes optimizing the content by varying a number of panels formed from the page of content based on display resources of the client device.

13. A method comprising:
obtaining a page of content formed as a plurality of panels;
determining which of the plurality of panels has a greater likelihood of being relevant to a user; and
outputting the determined relevant said panel for concurrent display with one or more identifiers of one or more of the other said panels.

14. A method as described in claim 13, wherein:
the determining is performed based on text included in a search query input by the user; and
the outputting is performed such that the determined relevant said panel is output before the other said panels.

15. A method as described in claim 13, wherein two said panels are not displayable at a single point in time.

16. A method as described in claim 13, wherein each said identifier is selectable to cause a respective said panel to be output for display.

17. One or more computer-readable media comprising executable instruction that, when executed, direct a computer to:
form a plurality of panels from a page of the content; and
form an identifier for each said panel from at least a portion of the content associated with a respective said panel.

18. One or more computer-readable media as described in claim 17, wherein at least one said panel includes an image and the identifier is formed from metadata associated with the image.

19. One or more computer-readable media as described in claim 17, wherein at least one said identifier is formed from a tag included in the content associated with the respective said panel.

20. One or more computer-readable media as described in claim 17, wherein at least said panel is configured for output such that each other said panel is accessible via a respective said identifier that is displayable concurrently with the at least one said panel
